(19) United States
(12) Patent Application Publication
(10) Pub. No.: US 2002/0098436 A1
(43) Pub. Date: Jul. 25, 2002

(54) Toner for use in electrophotography, image formation method using the toner, method of producing the toner, and apparatus for producing the toner

(76) Inventors: Satoru Miyamoto, Shizuoka (JP); Satoshi Mochizuki, Shizuoka (JP); Tomomi Suzuki, Shizuoka (JP); Masami Tomita, Shizuoka (JP)

Correspondence Address: Christopher C. Dunham, c/o Cooper & Cunham LLP, 1185 Ave. of the Americas, New York, NY, 10036, US

(21) Appl. No.: 10/032,172

(22) Filed: Dec. 21, 2001

Related U.S. Application Data
(63) Continuation of application No. 09/864,596, filed on May 24, 2001, now abandoned.
Application No. 09/864,596 is a continuation of application No. 09/384,797, filed on Aug. 27, 1999, now abandoned.

(30) Foreign Application Priority Data
Aug. 27, 1998 (JP) 10-256090

(51) Int. Cl. G03G 9/08

(52) U.S. Cl. 430/110.3; 430/111.41; 430/126; 430/47; 430/108.6

(57) ABSTRACT

A toner is proposed which includes toner particles and a fluidity-imparting agent and have such characteristics that the toner particles has an average circularity of 0.93 to 0.97, and that a residue of the toner is in an amount of 10 mg or less when 100 g of the toner is sieved with a 500-mesh sieve, which toner is for use in an electrophotographic image formation method using an intermediate image transfer method. A full-color image formation method, using this toner, and an image formation apparatus in which this toner is used are also proposed.

### BACKGROUND OF THE INVENTION

1. Field of the Invention

The present invention relates to a toner for developing a latent electrostatic image to a visible toner image for use in an electrophotographic image formation method, which may include an electrophotographic full-color image formation method, comprising a first image transfer step of transferring a toner image formed on a toner image bearing member from the toner image bearing member to an intermediate image transfer member such as an intermediate image transfer belt, and a second image transfer step of transferring the toner image from the intermediate image transfer member to an image transfer material.

The present invention also relates to an electrophotographic full-color image formation method, using the toner. The present invention also relates to a method of producing the toner, and an apparatus for producing the toner.

2. Discussion of Background

There are conventionally known an image formation method using an intermediate image transfer method, and an apparatus therefor, in which a plurality of visible developed color images is successively formed on an image bearing member such as a photoconductor and is then transferred in a superimposed manner to an intermediate image transfer member which runs along an endless path, such as an endless-belt-shaped intermediate image transfer member, thereby performing a first image transfer, and the thus transferred images are then en bloc transferred to an image transfer material, thereby performing a second image transfer.

The intermediate image transfer method is particularly used as an image transfer method of superimposing black, cyan, magenta and yellow toner images in a full-color image formation apparatus in which an original image is subjected to color separation, and is then reproduced, using a subtractive mixture of toners such as black, cyan, magenta and yellow toners.

When the above-mentioned image formation method and apparatus are used, it may occur that colored images with non-image transferred spots, for instance, in the form of worm-eaten spots, are formed on a final image transfer material due to the occurrence of local non-image transfer in the course of the above-mentioned first and second image transfer steps. In order to prevent the formation of such abnormal images, it is important to improve the image transfer performance of the toner so as to avoid the non-image transfer.

Conventionally, various technologies concerning such toners have been proposed to improve the image transfer performance thereof. However, no satisfactory solution has yet been made.

For instance, in connection with a shape coefficient of toner, there is proposed a toner provided with a shape coefficient SF-2 and a shape coefficient SP-2 in Japanese Laid-Open Patent Application 61-279864. However, nothing is mentioned about the image transfer performance of the toner in this reference. Therefore, an image transfer performance of a toner described in an example described in this reference was investigated. The result was that its image transfer efficiency was insufficient for use in practice and the toner needs further improvement.

In connection with the circularity of toner particles, several proposals have been made. For instance, in Japanese Laid-Open Patent Application 10-097095, there is proposed a toner defined by a ratio of the number of toner particles in relation with a temperature range of an endothermic peak and a level of the circularity of the toner particles. In the toner described in this reference, however, aggregates are apt to be formed in the toner so that the appearance of image defects, such as the formation of non-image transferred spots in a solid image, like the glow of fireflies in the dark, cannot be controlled when the level is such that toner particles with a circularity of 0.98 or more are present in an amount of less than 30% in terms of the percentage of the number of the toner particles.

In Japanese Laid-Open Patent Application 10-039537, there is proposed a toner defined by a relationship between a level of the circularity of toner particles and a ratio of the number of toner particles, more specifically, with the ratio of the number of toner particles with a circularity of 0.90 to less than 0.94 being 18% or less. An evaluation test of the toner with respect to the formation of non-image transferred spots in the form of worm-eaten spots indicates that the improvement of the toner on the prevention of the formation of non-image transferred spots was still insufficient for use in practice. In particular, an evaluation test of the toner, using an image formation apparatus provided with the above-mentioned intermediate image transfer member, indicates that no improvement effects were in fact observed on the quality of the toner.

In Japanese Patent Publication No. 2862827, there is proposed a toner defined with a ratio of the number of toner particles and an average circularity of the toner particles in relation with a ratio of an average particle diameter of the toner particles and a level of the circularity of the toner particles, more specifically, a toner defined with the ratio of the number of the toner particles with a circularity of 0.85 or less as being 3.0% or less. However, an evaluation test of the toner indicates that the range of the circularity defined in this reference is so broad that there is included in the defined range a toner which does not exhibit any improvement effects with respect to the formation of non-image transferred spots in the form of worm-eaten spots.

Furthermore, there is also proposed a definition of a toner which is separated by a sieve, with attention being paid to a residual toner remaining on the meshes of the sieve when the toner is sieved. For instance, in Japanese Laid-Open Patent Application 4-204660, a toner is defined by providing an average volume diameter of toner particles, a variation coefficient of the distribution of the number of toner particles, an amount of finely-divided particles of silica added, and a weight ratio of a residue of the toner remaining on the meshes of a 150-mesh sieve when sieved by the sieve. An evaluation test of the toner indicates that the proposed toner exhibits some improvement on the prevention of the formation of non-image transferred spots in the form of the glow of fireflies in the dark, but no improvement is observed on the prevention of the formation of non-image transferred spots in the form of worm-eaten spots.

### SUMMARY OF THE INVENTION

It is therefore a first object of the present invention to provide a toner for developing a latent electrostatic image to a visible toner image from which the above-mentioned conventional shortcomings have been eliminated, and which is capable of producing high quality toner images, without being affected by any toner dust, and free of local non-image transferred spots, for instance, in the form of worm-eaten spots or in the form of the glow of fireflies in the dark, for use in an electrophotographic image formation method, which may include such a full-color electrophotographic image formation method for forming a full-color image that comprises (1) a first image transfer step of repeating a plurality of times the transfer of a toner image successively from a toner image bearing member to an intermediate image transfer member such as an intermediate image transfer belt so as to form a superimposed toner image, and (2) a second image transfer step of transferring the superimposed toner image en bloc from the intermediate image transfer member to an image transfer material.

A second object of the present invention is to provide an electrophotographic full-color image formation method.

A third object of the present invention is to provide a method of producing the above-mentioned toner.

A fourth object of the present invention is to provide an apparatus for producing the toner.

A fifth object of the present invention is to provide a rotary toner supply container for use in the apparatus for producing the toner.

The first object of the present invention can be achieved by a toner comprising toner particles and a fluidity-imparting agent, the toner particles having an average circularity of 0.93 to 0.97, with a residue of the toner being in an amount of 10 mg or less when 130 g of the toner is sieved with a 500-mesh sieve, the toner being for use in an electrophotographic image formation method using an intermediate image transfer method which comprises (1) a first image transfer step of transferring a toner image formed on a toner image bearing member from the toner image bearing member to an endless-shaped intermediate image transfer member so as to form a toner image thereon, and (2) a second image transfer step of transferring the toner image from the intermediate image transfer member to an image transfer material.

The above toner may be any toner in a set of toners for use in a full-color electrophotography, which comprises at least a yellow toner, a magenta toner, and a cyan toner.

It is preferable that the above toner exhibit a charge rise-up ratio Z of 70% or more, which is calculated from formula (1):

Z(%)−(Q20/Q600)×100 (1)

wherein Q600 is a quantity of charge of the toner when the toner and a carrier are mixed and stirred for 10 minutes, with a concentration ratio of the toner in the mixture of the toner and the carrier being set at 5 wt. % or less at normal temperature and normal humidity, and Q20 is a quantity of charge of the toner when the toner is mixed with the carrier for 20 seconds under the same conditions as for the Q600.

It is preferable that the fluidity-imparting agent for use in the above toner comprise hydrophobic silica particles and hydrophobic titanium oxide particles, and that the fluidity-imparting agent has an average particle diameter of 0.05 μl or less.

Furthermore, it is preferable that the fluidity-imparting agent for use in the toner comprise hydrophobic silica particles with an average particle diameter of 0.05 μm or less in an amount of 0.3 to 1.5 wt. %, and hydrophobic titanium oxide particles with an average particle diameter of 0.05 μm or less in an amount of 0.3 to 1.5 wt. %.

It is also preferable that the toner have a volume mean diameter of 9 μm or less.

It is also preferable that the toner comprise toner particles with a particle size of 5 μm or less in an amount of 20% or less in terms of the percentage of the number of the toner particles contained therein.

The second object of the present invention can be achieved by a full-color image formation method for forming full-color images, using any of the above-mentioned toners, in which full-color electrophotographic image formation method, an intermediate image transfer method is used, which comprises (1) a first image transfer step of repeating a plurality of times the transfer of a toner image formed on a toner image bearing member successively from the toner image bearing member to an endless-shaped intermediate image transfer member so as to form a superimposed toner image, and (2) a second image transfer step of transferring the superimposed toner image en bloc from the intermediate image transfer member to an image transfer material.

In the above-mentioned full-color image formation method, it is preferable that the intermediate image transfer member have a volume resistivity of 10⁹ to 10¹³ ω•cm and a coefficient of surface friction of 0.4 or less.

Furthermore, in the above-mentioned full-color image formation method, it is preferable that the toner image formed on the toner image bearing member be such a toner image that is formed by developing a latent electrostatic image formed on a photoconductor drum, using a reversal development method in which there is rotated a development unit comprising a plurality of development devices and magnetic brushes therefor.

In the above-mentioned full-color image formation method, the toner may be held in a rotary toner supply container free of any rotary agitator blade, and the rotary toner supply container may be disposed in each of the development devices.

The third object of the present invention can be achieved by a method of producing the toner, which comprises the step of mixing a fluidity-imparting agent with a classified toner preparation material, using a rotary agitator blade mixer equipped with a rotary agitator blade, under the conditions which satisfy a formula:

50≦(V·T)/M≦200

wherein V is a peripheral speed (m/sec) of the rotary agitator blade of the rotary agitator blade mixer, T is a stirring and mixing time (sec), and M is a weight (kg) of the toner to be stirred and mixed.

In the above-mentioned method of producing the toner, (1) the classified toner preparation material may be obtained by subjecting a toner preparation material to secondary pulverizing, using a rotor type crusher comprising a fixed container serving as an external wall and a rotor having the same rotary shaft as that for the fixed container, (2) the toner preparation material subjected to the secondary pulverizing may be classified, using a pneumatic conveying classifier which is connected to the rotor type crusher, and (3) the pulverized and classified toner preparation material may be circulated through the rotor type crusher and the pneumatic conveying classifier.

Furthermore, in the above-mentioned method of producing the toner, the toner preparation material may be subjected to primary pulverizing, using a jet crusher comprising a detector, and compressed air, prior to the secondary pulverizing.

The fourth object of the present invention can be achieved by an apparatus for producing the toner, comprising:

a rotor type crusher comprising a fixed container serving as an external wall and a rotor having the same rotary shaft as that for the fixed container, and

a pneumatic conveying classifier which is connected to the rotor type crusher, through the rotor type crusher and the pneumatic conveying classifier, a classified toner preparation material being circulated.

The fifth object of the present invention can be achieved by a rotary toner supply container free of any rotary agitator blade, in which the above-mentioned toner is held.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is an electron microscopic photograph of the toner of the present invention with a magnification of 500 times.

FIG. 2A is an electron microscopic photograph with a magnification of 200 times of the residue of the toner of the present invention after the toner was sieved with the 500-mesh sieve.

FIG. 2B is an electron microscopic photograph with a magnification of 500 times of the residue of the toner of the present invention after the toner was sieved with the 500-mesh sieve.

FIG. 2C is an electron microscopic photograph with a magnification of 1500 times of the toner in the aggregated state.

FIG. 3A is a schematic cross-sectional view of a rotary agitator blade mixer for use in the present invention.

FIG. 3B is a schematic plan view of the rotary agitator blade mixer shown in FIG. 3A.

FIG. 4 is a schematic cross-sectional view of the rotor type crusher for use in the present invention.

FIG. 5 is a schematic cross-sectional view of an example of an image formation apparatus of the present invention, by which the image formation method of the present invention can be carried out, using the toner of the present invention.

### DESCRIPTION OF THE PREFERRED EMBODIMENTS

A method of producing the toner of the present invention will now be explained.

It is conventionally considered that image defects such as the formation of non-image transferred spots in the form of the glow of fireflies in the dark are caused by the presence of foreign materials such as aggregated toner particles or coarse particles in the toner. However, no solution has been discovered to the problem of the formation of such image defects. It may be considered that this problem can be solved by simply increasing the content of a fluidity-imparting agent in the toner. However, this will merely cause the abrasion of the surface of a photoconductor drum.

The inventors of the present invention have investigated factors that form aggregates in the toner which contains the fluidity-imparting agent.

The toner which contains the fluidity-imparting agent is produced by the steps of (1) kneading main components of the toner such as a coloring agent and a resin, (2) crushing the kneaded mixture to produce a roughly crushed toner preparation material for producing the toner, (3) subjecting the roughly crushed toner preparation material to primary pulverizing to produce a pulverized toner preparation material, (4) subjecting the pulverized toner preparation material to secondary pulverizing and classifying the secondary pulverized material to produce a classified toner preparation material, and (5) adding the fluidity-imparting agent to the classified toner preparation material and mixing the mixture to produce the toner which contains the fluidity-imparting agent.

Generally after the step (5) of adding the fluidity-imparting agent to the classified toner preparation material and mixing the mixture, there is taken a step of removing aggregated toner particles and/or coarse particles from the toner, using a sieve. The inventors of the present invention investigated the mechanism of this step in detail and discovered that in this step, coarse particles with a diameter larger than each opening of the meshes of the sieve can be in fact removed, and the aggregated toner particles are caused to collapse in the course of this step and pass through the meshes of the sieve, but again aggregate to form aggregated toner particles after they have passed through the sieve. The result is that such aggregated toner particles cannot be removed from the toner even when the toner is caused to pass through the sieve.

The inventors of the present invention have also discovered that the circularity of toner particles has a close relationship with the formation of the aggregated toner particles. More specifically, the greater the circularity of the toner particles, the more easily the aggregated toner particles tend to be formed. The invention of the present invention is based on this discovery.

More specifically, the toner of the present invention comprises toner particles and a fluidity-imparting agent, and the toner particles have an average circularity of 0.93 to 0.97. A residue of the toner is in an amount of 10 mg or less when 100 g of the toner is sieved with a 500-mesh sieve.

The above toner of the present invention is particularly effective in preventing local improper image transfer such as non-image transfer with the formation of non-image transferred spots in the form of worm-eaten spots and/or in the form of the glow of fireflies in the dark, when used in the image formation method using the intermediate image transfer method. The toner of the present invention can also be employed in other image formation methods.

In the present invention, the circularity of toner particles is measured, using a commercially available Flow particle Image Analyzer (Trademark “FPIA-1000” made by Toa Medical Electronics Co., Ltd.), and the circularity of toner particles in the residue which remains on the meshes of the sieve after the sieving of the toner is measured by dispersing the residue in a commercially available surfactant (Trademark “Drywell” made by Fuji Photo Film Co., Ltd.) which is diluted with distilled water.

The residue of the toner which remains on the meshes of the sieve is collected, using an ultrasonic vibration sieve (Trademark “VIBRO SEPARATOR WITH ULTRASONICS TMR-50-1S Type” made by Tokuju Kosakusho Co., Ltd.), provided with a 500-mesh screen (the opening diameter: 25 μm, the thickness of wire: 25 μm, and the material: SUS316), with vibrations with a frequency of 36 kHz. The residue contains the above-mentioned aggregated toner particles and coarse particles.

The method of producing the toner of the present invention is not limited to a particular method. However, the inventors of the present invention have discovered that when a rotary agitator blade mixer is used in the above-mentioned step (5) of adding the fluidity-imparting agent to the classified toner preparation material and mixing the mixture to produce the toner which contains the fluidity-imparting agent, and too high a stress is applied to the mixture, a surface of the toner particles is fused by the heat generated within the mixer, so that a spherical-particle-formation phenomenon that the toner particles are made spherical in shape takes place or the fluidity-imparting agent is embedded in the toner particles. In particular, in the case of color toners, a color tone is reproduced by superimposing primary colors of yellow, magenta and cyan, so that toners with a relatively low softening point, containing therein a large quantity of low-molecular-weight resin components, are in general use. When such low-molecular-weight resin components are used in the toner, the above-mentioned spherical-particle-formation phenomenon conspicuously occurs within the mixer, so that the circularity of the toner particles is increased.

Based on the above discovery by the inventors of the present invention, the inventors of the present invention have discovered that the following conditions under which the circularity of toner particles can be appropriately adjusted when the fluidity-imparting agent is added to and mixed with the classified toner preparation material, using the rotary agitator blade mixer equipped with a rotary agitator blade:

50<(V•T)/M<200

wherein V is a peripheral speed (m/sec) of the rotary agitator blade of the rotary agitator blade mixer, T is a stirring time (sec), and M is a weight (kg) of the toner to be stirred and mixed.

In other words, when the above conditions are satisfied, the above-mentioned spherical-particle-formation phenomenon can be appropriately adjusted even if the fluidity-imparting agent is mixed with the classified toner preparation material, so that the toner having an appropriate circularity, without causing the embedding of the fluidity-imparting agent to the toner particles, can be effectively produced.

In the case where the stress applied to the toner is excessive when the fluidity-imparting agent is mixed in the rotary agitator blade mixer, that is, in the case where (V•T)/M>200, the circularity of the toner particles thereof is non-uniform, and when the toner is sieved using a 500-mesh sieve, there is found a great difference in level between the circularity of the residual toner which remains on the meshes of the sieve and the circularity of the toner which passes through the meshes of the sieve, with the residual toner which remains on the meshes of the sieve having much higher circularity than that of the toner which passes through the meshes of the sieve.

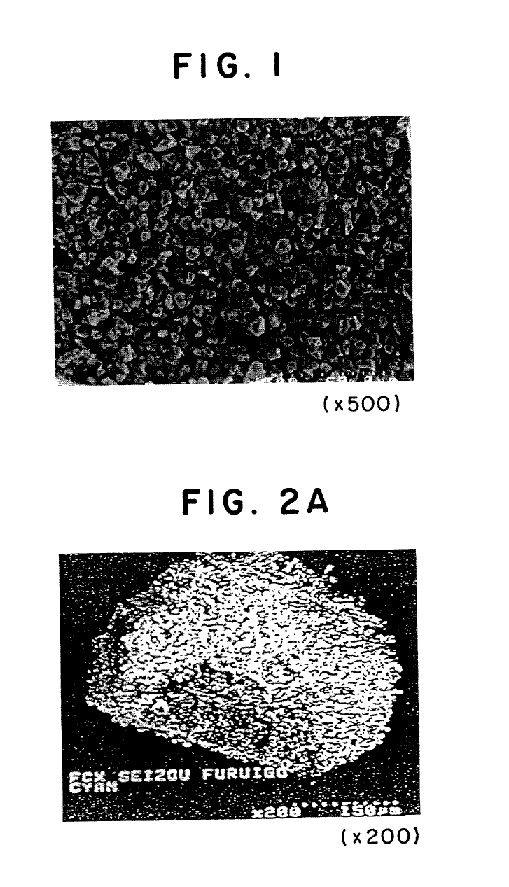

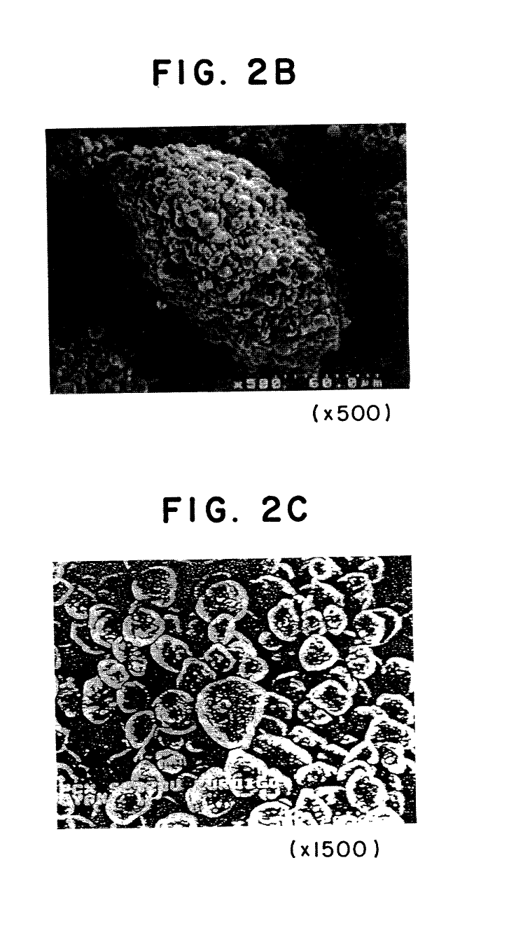

FIG. 1 is an electron microscopic photograph of the toner of the present invention with a magnification of 500 times. FIG. 2A is an electron microscopic photograph with a magnification of 200 times of the residue of the toner of the present invention after the toner was sieved with the 500-mesh sieve, and FIG. 2B is an electron microscopic photograph with a magnification of 500 times of the residue of the toner of the present invention after the toner was sieved with the 500-mesh sieve, these showing that the residue is in an aggregated state. FIG. 2C is an electron microscopic photograph with a magnification of 1500 times of the toner in the aggregated state, showing that the toner particles in the aggregated state are more spherical than the toner particles of the toner of the present invention.

In the case of (V•T)/M<50, that is, in the case where the stress applied to the toner is insufficient when the fluidity-imparting agent is mixed in the rotary agitator blade mixer, the fluidity-imparting agent is not uniformly mixed with the classified toner preparation material, so that the toner with the desired fluidity cannot be obtained. Furthermore, when this toner is sieved with the 500-mesh sieve, coarse particles of the fluidity-imparting agent and finely-divided toner particles without the deposition of the fluidity-imparting agent thereon are apt to remain in the toner, causing the image defects such as the non-image transferred spots in the form of the glow of fireflies in the dark and/or in the form of worm-eaten spots.

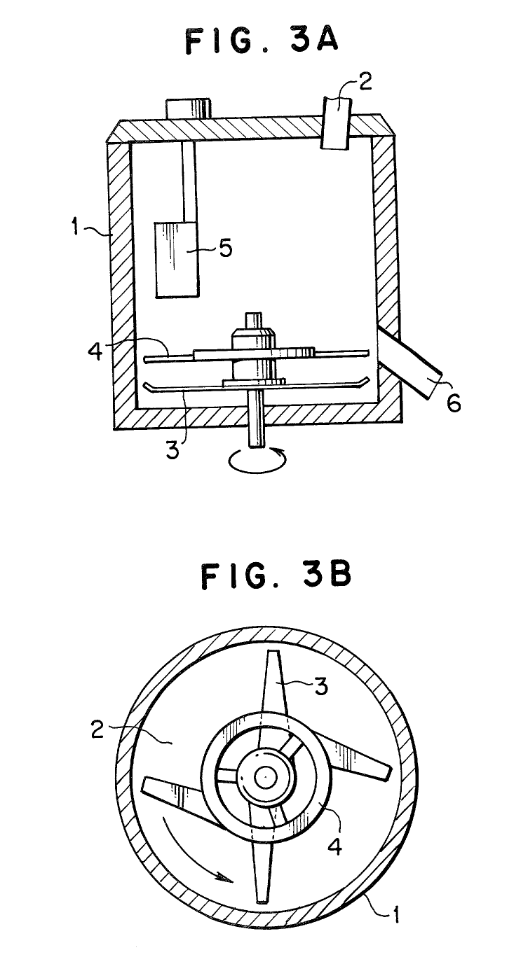

FIG. 3A and FIG. 3B show the rotary agitator blade mixer. FIG. 3A is a schematic cross-sectional view of the rotary agitator blade mixer, and FIG. 3B is a schematic plan view of the rotary agitator blade mixer when viewed from above a top thereof. The rotary agitator blade mixer is generally in a cylindrical shape and has a capacity of about 40 to 1000 liters. In a test conducted, a rotary agitator blade mixer with a capacity of about 200 liters was employed. In FIGS. 3A and 3B, reference numeral 1 indicates a wall of the mixer; reference numeral 2, an inlet through which a material to be mixed is placed in the mixer therethrough; reference numerals 3 and 4, a rotary agitator blade; reference numeral 5, a detector against which powder is caused to strike; and reference numeral 6, an outlet through which a product is discharged from the mixer.

The classified toner preparation material and the fluidity-imparting agent are successively placed in the mixer through the inlet 2, and are mixed by the rotary blades 3 and 4 which rotate at 700 to 1000 rpm, and are caused to strike against the detector 5 and the wall 1, whereby the fluidity-imparting agent is deposited on the surface of finely-divided particles of the classified toner preparation material. The revolution is adjusted in such a manner that the fluidity-imparting agent is not embedded in the particles of the classified toner preparation material, and that the particles do not become spherical in their entirety, whereby the toner of the present invention is prepared and discharged from the mixer through the outlet 6.

The inventors of the present invention have studied an apparatus for use in the step (4) subjecting the pulverized material to secondary pulverizing and classifying the secondary pulverized material to produce the classified toner preparation material, and constructed a rotor type crusher which comprises as main members a fixed container serving as an external wall and a rotor having the same rotary shaft as that for the fixed container, with such a mechanism that the rotor type crusher is connected to a pneumatic conveying classifier. In this mechanism, the toner preparation material subjected to primary pulverizing in the rotor type crusher is classified by the pneumatic conveying classifier, and the toner preparation material subjected to primary pulverizing is then circulated through the rotor type crusher and the pneumatic conveying classifier, whereby there can be obtained a secondary pulverized and classified toner preparation material, not only with the desired particle diameter, but also with the desired circularity by adjusting the circulation time.

The secondary pulverized and classified toner preparation material thus obtained is moved onto the above-mentioned step (5), whereby the toner of the present invention capable of producing high quality toner images free of the above-mentioned image defects such as the formation of non-image transferred spots can be obtained.

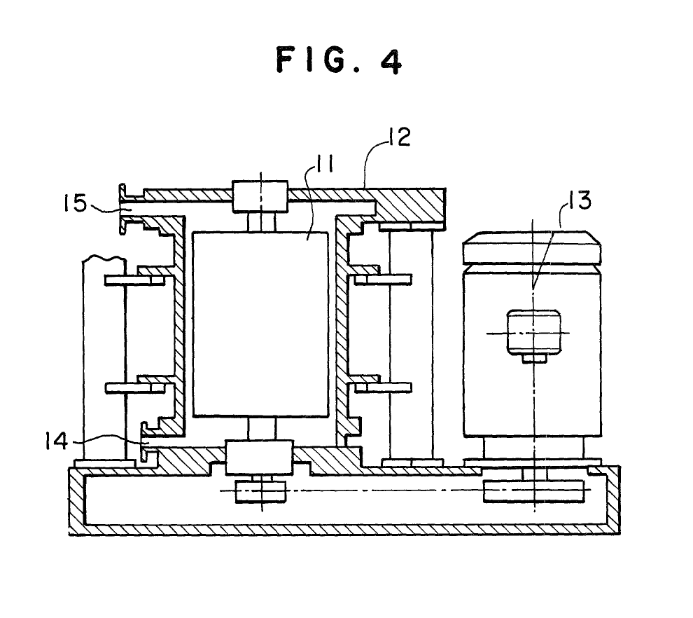

FIG. 4 is a schematic cross-sectional view of the rotor type crusher which is to be connected to the pneumatic conveying classifier. The rotor type crusher is cylinder-shaped. In FIG. 4, reference numeral 11 indicates a rotor; reference numeral 12, a stator which supports and surrounds the rotor 11; reference numeral 13, a motor; reference numeral 14, an inlet for placing the toner preparation material in the crusher; and reference numeral 15, an outlet for discharging crushed toner preparation material from the crusher. The inlet 14 and the outlet 15 are connected to the pneumatic conveying classifier. The rotor 11 revolves at 1500 to 1600 rpm. The revolution of the rotor 11 generates a gyratory flow of air between grooves formed at an outer wall of the rotor 11 and grooves formed at an inner wall of the stator 12, and the toner preparation material is subjected to secondary pulverizing by the gyratory flow of air.

Out of the toner preparation material which has been subjected to the secondary pulverizing by the rotor 11, and has then passed through the pneumatic conveying classifier, the toner particles having the desired particle diameter and the shape are taken out as the toner particles to be mixed with the fluidity-imparting agent in the next step. However, the toner particles which do not have the desired particle diameter, for instance, having a larger particle size than the desired particle size, are again placed in the crusher through the inlet 14. Thus, the toner preparation material to be placed in the crusher through the inlet 14 includes the toner preparation material subjected to the primary pulverizing obtained in the step (3) and the above-mentioned toner particles which do not have the desired particle diameter.

The toner for use in electrophotography of the present invention and the preparation method thereof will now be explained in detail.

The toner preparation material comprises a binder resin, a coloring agent, a release agent, and a charge control agent.

Any binder resins used in the conventional toners are usable.

Specific examples of such a binder resin for use in the present invention include homopolymers of styrene or substituted styrenes such as polystyrene, polychlorostyrene, and polyvinyltoluene; styrene-based copolymers such as styrene-p-chlorostyrene copolymer, styrene-propylene copolymer, styrene-vinyltoluene copolymer, styrene-vinylnaphthalene copolymer, styrene-methyl acrylate copolymer, styrene-ethyl acrylate copolymer, styrene-butyl acrylate copolymer, styrene-octyl acrylate copolymer, styrene-methyl methacrylate copolymer, styrene-ethyl methacrylate copolymer, styrene-butyl methacrylate copolymer, styrene-methyl α-chloromethacrylate copolymer, styrene-acrylonitrile copolymer, styrene-vinylethyl ether copolymer, styrene-vinylmethyl ketone copolymer, styrene-butadiene copolymer, styrene-isoprene copolymer, styrene-acrylonitrile-indene copolymer, styrene-maleic acid copolymer, and styrene-maleic acid ester copolymer; and poly(methyl methacrylate), poly(butyl methacrylate), polyvinyl chloride, polyvinyl acetate, polyethylene, polypropylene, polyester, polyvinylbutyl butyral, polyacrylic resin, rosin, modified rosin, terpene resin, phenolic resin, aliphatic hydrocarbon resin, alicyclic hydrocarbon resin, aromatic petroleum resin, chlorinated paraffin, and paraffin wax. These binder resins can be used alone or in combination.

Any dyes and pigments capable of producing a yellow toner, a magenta toner, a cyan toner or a black toner can be used as the coloring agents in the present invention. There can be employed any dyes and pigments for use in the conventional toners.

Specific examples of the coloring agents for use in the present invention include nigrosine dyes, aniline blue, Chalco Oil Blue, Du Pont Oil Red, Quinoline yellow, methylene blue chloride, phthalocyanine blue, phthalocyanine green, Hansa Yellow G, Rhodamine 6G Lake, chrome yellow, quinacridone, Benzidin: Yellow, Malachite Green, Malachite Green Hexalate, Rose Bengale, monoazo pigments, disazo pigments and trisazo pigments.

It is preferable that the amount of such a coloring agent be in the range of 1 to 30 wt. %, more preferably in the range of 3 to 20 wt. %, of the entire weight of the binder resin.

Both a positive charge control agent and a negative charge control agent are usable as the charge control agent for use in the toner of the present invention. For the preparation of a color toner, it is preferable to employ a transparent or white charge control agent, in order that the color of the color toner be not impaired by the addition of the charge control agent thereto.

Specific examples of the positive charge control agent are quaternary ammonium salts, and imidazole metal complexes and salts thereof; and specific examples of the negative charge control agent are salicylic acid metal complexes and salts thereof, organic boron salts, and calixarene compounds.

In order to impart the release properties to the toner of the present invention, there can be employed a release agent.

Specific examples of the release agent for use in the present invention include synthetic waxes such as low molecular weight polyethylene and polypropylene;

vegetable waxes such as candelilla wax, carnauba wax, rice wax, Japan wax and jojoba oil; animal waxes such as bees wax, lanolin, and spermaceti; mineral waxes such as montan wax and ozocerite, and fats and oils such as hardened castor oil, hydroxystearic acid, fatty acid amides, and phenolic fatty acid ester. Those can be used alone or in combination.

The toner according to the present invention may further comprise an assistant such as a plasticizer and a resistivity controlling agent, when necessary, for the purpose of controlling the thermal properties, electrical characteristics and physical properties of the toner.

Examples of the plasticizer are dibutyl phthalate and dioctyl phthalate.

Examples of the resistivity controlling agent are tin oxide, lead oxide, and antimony oxide.

Furthermore, the toner of the present invention comprises a fluidity-imparting agent.

Specific examples of the fluidity-imparting agent for use in the present invention include finely-divided particles of silica, titanium oxide, aluminum oxide, magnesium fluoride, silicon carbide, boron carbide, titanium carbide, zirconium carbide, boron nitride, titanium nitride, zirconium nitride, magnetite, molybdenum disulfide, aluminum stearate, magnesium stearate, zinc stearate, fluoroplastic and acrylic resin. These fluidity-imparting agents may be used alone or in combination.

It is preferable that primary particles of the fluidity-imparting agent have a particle size of 0.1 μm or less. In addition, with respect to the fluidity-imparting agent, the surfaces of finely-divided particles be treated to become hydrophobic using a silane coupling agent and a silicone oil so as to have a hydrophobic degree of 40 or more.

In particular, it is preferable that the fluidity-imparting agent comprise hydrophobic silica particles and hydrophobic titanium oxide particles. In this case, it is preferable that the fluidity-imparting agent have an average particle diameter of 0.05 μm or less. When such a fluidity-imparting agent is mixed and stirred with the toner preparation material, the electrostatic force and the Van der Waals force between the particles of the above-mentioned fluidity-imparting agent and the toner preparation material are extremely improved. Therefore, the fluidity-imparting agent can be prevented from falling off the particles of the toner preparation material while the toner is stirred in the development device to obtain a desired charge quantity. Accordingly, high quality toner images can be obtained free of the formation of non-image transferred spots in the form of the glow of fireflies in the dark, and in addition, the amount of toner remaining on the toner image bearing member after image transfer step can be reduced.

The titanium oxide particles are superior in terms of the environmental stability and the stability of the image density of obtained toner images, while inferior in terms of the charge rise-up properties. Therefore, it is considered that the charge rise-up properties of toner become poor when the amount of the titanium oxide particles is more than that of the silica particles.

When the fluidity-imparting agent comprises the hydrophobic silica particles in an amount of 0.3 to 1.5 wt. %, and the hydrophobic titanium oxide particles in an amount of 0.3 to 1.5 wt. %, the charge rise-up properties are not seriously impaired. In addition, desired charge rise-up properties of toner can be obtained by conducting the proper sphericity adjustment treatment. Namely, the image quality of the obtained toner images is stable even after repeated copying operations, and scattering of toner particles from the development device can be effectively prevented.

It is preferable that the toner of the present invention have a charge rise-up ratio (Z) of 70% or more, the charge rise-up ratio being calculated from formula (1):

Z(%)=(Q20/Q600)×100

wherein Q600 is a charge quantity of toner when the toner and a carrier are mixed and stirred at normal temperature and normal humidity for 10 minutes, with a concentration ratio of the toner in the mixture of the toner and the carrier being set at 5 wt. % or less, and Q20 is a charge quantity of toner when the toner is stirred and mixed with the carrier under the same conditions as mentioned above for 20 seconds.

When the charge rise-up ratio of the toner is 70% or more, the image transfer efficiency c~n be remarkably improved. The charge quantity of developer, the fluidity of toner, the electric resistivity of toner, and the shape of toner particles are the factors that affect the image transfer efficiency, in particular, the charge quantity, the fluidity, and the shape of toner particles become the key factors.

Since the toner of the present invention has excellent charge rise-up properties, the toner can readily exert electrostatic force and the Van der Waals force on the carrier and the blade, so that a desired charge quantity of toner can be obtained in a short time. This makes it-possible to efficiently carry out the development step and the image transfer step, and prevent the scattering of toner particles from the development device.

It is desirable that the toner of the present invention have a volume mean diameter of 9 μm or less. In light of the improvement of resolution of the toner image, it is essential to decrease the particle size of toner particles. However, in general, the reduction of the particle size of toner particles has an adverse effect on the deterioration of fluidity and preservation stability.

According to the present invention, even though the volume mean diameter of the toner particles is 9 μm or less, the fluidity and the preservation stability of the toner can be maintained at a satisfactory level and the resolution can be improved to produce high quality toner images by mixing the previously mentioned fluidity-imparting agent with the toner preparation material and employing the sphericity adjustment treatment using the rotary crusher. In this case, the average circularity of toner is required to be controlled to 0.93 to 0.97

It is preferable that the toner comprise finely-divided particles with a particle size of 5 μm or less in an amount of 20% or less in terms of the percentage of the number of the toner particles contained therein. By such control of the content of finely-divided particles, the characteristics of toner, such as the fluidity and the preservation stability, can be remarkably improved, and the toner replenishment performance in the development device and the charge rise-up properties of toner can maintain a high level.

The particle diameter distribution of the toner of the present invention is measured by Coulter counter method, although there are other different kinds of methods. The measurement was carried out using a commercially available measuring apparatus (Trademark “Coulter Counter TA II”, made by Coulter Electronics Ltd.). A 1% aqueous solution of sodium chloride is used as an electrolyte and the aperture may be adjusted to 100 μm.

The method of producing the toner according to the present invention will now be explained in detail.

For instance, a binder resin, a coloring agent and a charge control agent, optionally in combination with a release agent, in an appropriate mixing ratio, are sufficiently blended in a mixer such as a Henschel mixer or a ball mill, and thereafter the mixture is fused and kneaded, using a screw extruder type continuous kneader, a two-roll mill, a three-roll mill, or a pressure and heat application kneader.

The thus kneaded mixture is cooled and solidified, and then roughly ground in a mill such as a harmer mill, whereby a roughly ground toner preparation material is obtained. For the preparation of a color toner, a master batch is generally used as a coloring agent, which is prepared by fusing and kneading a pigment and part of a binder resin in advance to improve the dispersion properties of the pigment in the binder resin.

Next, the roughly ground toner preparation material is then pulverized, using a jet mill, and then subjected to surface treatment, using a rotor type crusher connected to a pneumatic conveying classifier. As a detector type crusher, there can be used, for example, a hammer mill, a ball mill, a tube mill and an oscillating mill.

As the jet mill provided with compressed air and a detector as the main components thereof, commercially available jet mills under the trademark of “Super Sonic Jet Mill I-Type” or “Super Sonic Jet Mill IDS-Type”, made by Nippon Pneumatic Mfg. Co., Ltd., are preferably employed.

As the rotor type crusher, there can be employed, for example, a roll mill, a pin mill, and a fluidized bed jet mill. A rotor type crusher comprising as the main members a fixed container serving as an external wall and a rotor having the same rotary shaft as that for the fixed container is particularly preferably employed. As this kind of rotor type crusher, there can be employed commercially available crushers “Turbo Mill” (Trademark), made by Turbo Kogyo Co., Ltd.; “Kryptron” (Trademark), made by Kawasaki Heavy Industries, Ltd.; and “Fine Mill” (Trademark), made by Nippon Pneumatic Mfg. Co., Ltd.

As mentioned above, in the present invention, an apparatus with a special structure in which the rotor type crusher is connected to a pneumatic conveying classifier is proposed as being particularly effective for producing the toner of the present invention.

As the classifier to be connected to the above-mentioned rotor type crusher, conventionally known pneumatic conveying classifiers and mechanical classifiers can be employed. In the method of producing the toner according to the present invention, it is preferable to use a pneumatic conveying classifier.

As the pneumatic conveying classifiers, “Dispersion Separator DS-Type” (Trademark), made by Nippon Pneumatic Mfg. Co., Ltd., and “Elbowjet” (Trademark). made by Nittetsu Mining Co., Ltd., which is a multi-segment type classifier, are commercially available. For use in the present invention, the former is particularly preferable.

The reasons why it is preferable to use the pneumatic conveying classifier in the present invention are that the mechanical classifier is inferior to the pneumatic conveying classifier in terms of classifying accuracy, and is difficult to perform particle size adjustment when classifying conditions are changed because the mechanical classifier has less choices in the particle size adjustment modes than those selected by the pneumatic conveying classifier. Furthermore, the mechanical classifier is more difficult in the maintenance thereof in the course of switching the classification conditions than the pneumatic conveying classifier.

When the above-mentioned multi-segment type classifier such as “Elbowjet” (Trademark), using the Coanda effect, is compared with the pneumatic conveying classifier, “Dispersion Separator DS-Type” (Trademark), the multi-segment type classifier is disadvantageous in classifying accuracy because the particles cannot be sufficiently dispersed, in particular, when the particles comprises a release agent.

Furthermore, when the fluidity-imparting agent is added to the finely-divided particles of the classified toner preparation material obtained by the above-mentioned pulverizing and classifying method, the conventional mixers, such as a commercially available Henschel mixer (made by Mitsui Mining Co., Ltd.), a super mixer (made by Kawata Mfg. Co., Ltd.), and a ball mill can be used.

One of the factors to control the circularity of the toner particles is the residence time of the toner preparation material in the rotor type crusher. For instance, when there is employed the rotor type crusher “Kryptron” (Trademark), made by Kawasaki Heavy Industries, Ltd., which is not provided with any classifier, the crushed particles are sent to the next step without staying in the rotor type crusher. The shape of the particles crushed by this rotor type crusher does not change at all when compared with the shape of the particles crushed by the jet crusher. The levels of the fluidity and the aggregation degree of toner particles are scarcely improved when the rotor type crusher without a classifier is employed. In this case, therefore, the effect of improving the image quality is unsatisfactory.

On the other hand, when the residence time of the toner preparation material in the rotor type crusher is too long, in other words, when the amount of particles returned back to the crusher from the classifier is increased, the toner particles tend to become spherical in shape. However, when the sphericity of the toner particles is excessive, the toner particles tend to aggregate readily, causing the formation of defective images.

The method for producing the toner of the present invention is apparently distinguishable from the conventional method disclosed in Japanese Patent Publication 8-20762 that is capable of performing the surface modification in a short time. The pneumatic conveying classifier is essential in an apparatus for producing a toner according to the present invention, and the classified toner preparation material is circulated through the rotor type crusher and the pneumatic conveying classifier to control the residence time in the rotor type crusher. Thus, a desired average circularity of toner particles can be obtained.

The intermediate image transfer member for use with the full-color image formation method of the present invention will now be explained in detail.

To more effectively prevent incomplete image transfer due to the formation of non-image transferred spots in the form of worm-eaten like spots and the formation of non-image transferred spots in the form of the glow of fireflies in the dark, and defective image reproduction due to the occurrence of toner deposition on the background, it is preferable that the intermediate less.

When the above-mentioned coefficient of surface friction exceeds 0.4, the release properties of the intermediate image transfer member are degraded, so that worm-eaten like spots tend to be easily formed in the transferred image. Further, the frictional load caused by a cleaning blade increases, thereby causing defective cleaning performance. To obtain the intermediate image transfer member with the above-mentioned coefficient of surface friction, it is preferable to employ a material with such friction properties for the preparation of the intermediate image transfer member, or to control the friction properties of the intermediate image transfer member by the addition of an additive.

When the volume resistivity of the intermediate image transfer member is less than the above-mentioned range, a transfer bias readily causes electrical discharge at the contact portion between the photoconductor and the intermediate image transfer member. Such electrical discharge will disturb the image formation. On the other hand, when the volume resistivity becomes greater than the aforementioned range, image transfer will not be achieved unless the transfer bias is abnormally increased. In addition, since the electric charge is apt to remain and accumulate in the intermediate image transfer member, there is a risk of ghost images appearing on an image transfer material.

To obtain the previously mentioned volume resistivity of the intermediate image transfer member, an inorganic or organic electroconductive material may be added to a resin material constituting the intermediate image transfer member.

The volume resistivity of the intermediate image transfer member is measured by use of a commercially available measuring apparatus “HIRESTA-UP” (Trademark), made by DIA Instruments Co., Ltd.; and the coefficient of surface friction thereof, by use of a commercially available friction abrasion analyser “DFPM-SS” (Trademark), made by Kyowa Interface Science Co., Ltd.

It is preferable that the surface portion of the intermediate image transfer member comprise a fluorine-containing resin.

Examples of the fluorine-containing resin for use in the intermediate image transfer member are polyvinylidene fluoride (PVdF), polytetrafluoroethylene (PTFE), tetrafluoroethylene-ethylene copolymer (ETFE), polychlorotrifluoroethylene (PCTFE), tetrafluoroethylene-hexafluoropropylene copolymer (EEP), and tetrafluoroethylene-hexafluorapropylene-vinylidene fluoride copolymer (THV).

Of these fluorine-containing resins, PVdF and THV are particularly preferable in terms of moldability. To satisfactorily achieve the full-color image formation process of the present invention using the intermediate image transfer member, the intermediate Stage transfer member may have a coefficient of surface friction of 0.4 or less, as previously described. To obtain such a coefficient of surface frictions a material with the above-mentioned coefficient of surface friction may be employed, or an additive may be contained in the material for use in the intermediate image transfer member to control the coefficient of surface friction.

Specific examples of the additive for controlling the coefficient of surface friction of the intermediate image transfer member are silicon- or fluorine-containing low molecular weight additives such as a silicone oil and a fluorochemical surfactant; powders of silicone resin and fluoroplastics; inorganic solid lubricants such as mica, graphite, and molybdenum disulfide; and a variety of waxes including natural waxes such as montan wax, carnauba wax and hardened castor oil, synthetic waxes such as fatty ester, triglyceride of fatty acid, fatty alcohol, fatty monoamide, and fatty bisamide, and polyolefin waxes such as polyethylene wax and polypropylene wax.

As previously mentioned, to obtain a desired volume resistivity of the intermediate image transfer member, inorganic or organic electroconductive materials may be added to the resin material.

In this case, conventional inorganic electroconductive materials are usable. For example, carbon black, graphite, carbon fibers, metal powder, metallic oxide powder, and electroconductive whisker can be added for adjusting the volume resistivity.

As the organic electroconductive materials, there can be employed polyethylene oxide, polypyrrole, and quaternary ammonium salts.

Those inorganic or organic electroconductive materials may be used alone or in combination. The amount of electroconductive material may be controlled to obtain a predetermined volume resistivity.

When the color toners obtained by the method of the present invention are set in an electrophotographic apparatus capable of achieving full-color image formation by developing a latent electrostatic image formed on a photoconductor drum, using a reversal development method, in which there is rotated a development unit comprising a plurality of development devices and magnetic brushes therefor, the image quality of the obtained toner images is drastically improved.

In general, the development unit of the above-mentioned electrophotographic apparatus is provided with a toner supply container. The rotary toner supply container according to the present invention is free of any rotary agitator blade that is conventionally required to prevent the bridge of toner particles in the toner supply container. With the rotation of the development unit, toner is supplied to the development device by its own weight. Therefore, agglomerates of toner particles are not readily formed in the development unit for use in the present invention unlike the conventional one of a screw extruder type.

When a set of full color toners each having a charge rise-up ratio of 70% or more is subjected to image formation, the image density can be stabilized, high quality images can be obtained free of any defective image, and the amount of residual toner that is not contributed to image transfer can be effectively reduced

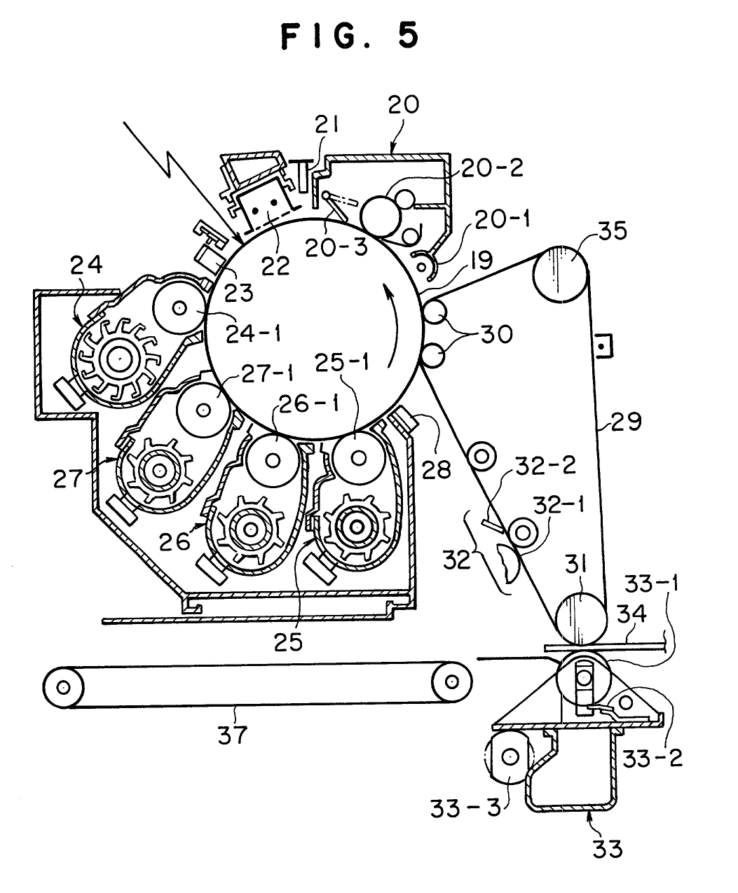

With reference to FIG. 5, the image formation method and an apparatus therefor of the present intention will now be explained in more detail.

In the apparatus shown in FIG. 5, a latent electrostatic image corresponding to an original image is formed on a photoconductor 19 by the steps of converting color image data output from a color scanner (not shown) into optical signals, and performing optical writing corresponding to the original image in the photoconductor 19, based on the optical images, using an optical writing unit (not shown). The optical writing unit itself is conventionally known and is composed of, for example, a laser diode, a polygon mirror, a polygon motor, an image formation lens, and a reflecting mirror. The photoconductor 19 is rotated counterclockwise in the direction of the arrow. Around the photoconductor 19, there are situated a cleaning unit 20 which includes a cleaning pre-charger 20-1, a brush roller 20-2 and a rubber blade 20-3, a quenching lamp 21, a charger 22, a potential sensor 23, a black development device 24, a cyan development device 25, a magenta development device 26, a yellow development device 27, a developed density pattern detector 28, and an intermediate image transfer belt 29. The development devices 24 to 27 are respectively composed of rotating development sleeves 24-1 to 27-1 for directing a developer for developing a latent electrostatic image to the photoconductor 19, a paddle for scooping up and stirring each developer, and a sensor for detecting the toner concentration of each developer.

The development operation will now be explained, taking as an example a development procedure conducted in the order of black, cyan, magenta and yellow, which are respectively represented by Bk, C, M and Y hereinafter. The order of the colors in the development is not limited to the above order.

When a copying operation is initiated, reading of Bk image data is started with a predetermined timing by the color scanner (not shown), and optical writing is performed, based on the read Bk image data, using a laser beam, and the formation of a latent electrostatic image based on the Bk image data (hereinafter referred to as Bk latent image) is initiated. In order to make it possible to perform the development of the Bk latent image from a leading edge portion thereof, the rotation of the development sleeve 24-1 is initiated before the leading edge portion of the Bk latent image reaches a development position of the Bk development device 24, whereby the Bk latent image is developed with a Bk toner with a minimum quantity of charge being maintained. Thereafter, the development operation is continued in the Bk latent image area and when a rear edge portion of the Bk latent image has passed the Bk development position, the development operation is made inoperative. This step is completed at latest before a leading edge portion of a C (cyan) latent image reaches its development position.

A Bk toner image formed on the photoconductor 19 is then transferred to a surface of the intermediate image transfer belt 29 which is driven in rotation at the same speed as that of the photoconductor 19. This toner image transfer is hereinafter referred to as the first image transfer. The first image transfer is carried out while the photoconductor 19 and the intermediate image transfer belt 29 are in contact, with the application of an image transfer bias voltage thereto Thereafter, Bk, C, M and Y toner images which are successively formed on the photoconductor 19 are successively transferred to the same side of the intermediate image transfer belt 29 and are superimposed with positional registration to form a four-color-superimposed first transferred image on the intermediate image transfer belt 29. The thus formed four-color-superimposed first transferred image is then transferred en bloc to an image transfer sheet. This image transfer is referred to as the second image transfer. The structure of a unit including the intermediate image transfer belt 29 and the operation thereof will be explained later.

After the step of developing the Bk latent image, there is initiated a step of developing a cyan latent image with a cyan toner with a secondary small quantity of charges.

Reading of C image data is started with a predetermined timing by the color scanner (not shown), and the optical writing is performed, based on the read C image data, using a laser beam, and the formation of a latent electrostatic image based on the C image data (hereinafter referred to as C latent image) is initiated.

In the cyan development device 25, the rotation of the development sleeve 25-1 is initiated after the rear edge portion of the Bk latent image passes its development position, and before the leading edge portion of the C latent image reaches a development position of the C development device 25, whereby the C latent image is developed with the C toner with the secondary small quantity of charge being maintained. Thereafter, the development operation is continued in the C latent image area and when a rear edge portion of the C latent image has passed the C development position, the development operation is made inoperative in the same manner as in the above-mentioned Bk development device. This step is completed at latest before a leading edge portion of the next M (cyan) latent image reaches its development position.

The steps of developing a M (magenta) latent image and a Y (yellow) latent image are caused to proceed in the same manner as in the step of developing the Bk latent image with respect to the reading of the respective image data, the formation of the respective latent images, and the development thereof except that the respective M toner and Y toner have an increased quantity of charges in this order.

The intermediate image transfer belt 29 is trained over image transfer bias rollers 30, a drive roller 31, and a driven roller 35, and the driving of the intermediate image transfer belt 29 is controlled by a drive motor (not shown). A belt cleaning unit 32 is composed of a brush roller 32-1, about a half of which is exposed, and a rubber blade 32-2, and is constructed so as to be detachable from the intermediate image transfer belt 29 by a detaching mechanism (not shown). The cleaning of the intermediate image transfer belt 29 is conducted with such a timing of the detaching operation that the belt cleaning unit 32 is kept detached from the surface of the intermediate image transfer belt 29 until the first image transfer (in this example, from the start of the printing through the transfer of the Y toner image which is the fourth color image) has been completed, and is then brought into contact with the surface of the intermediate image transfer belt 29 with a predetermined timing by the above-mentioned detaching mechanism.

A sheet image transfer unit 33 is composed of a sheet image transfer bias roller 33-1 serving as electric field formation means for second image transfer, a roller cleaning blade 33-2, and a detaching mechanism 33-3 for the detachment of the sheet image transfer unit 33 from the intermediate image transfer belt 29. The sheet image transfer bias roller 33-1 is usually out of contact with the intermediate image transfer belt 29, but is brought into contact with the intermediate image transfer belt 29 by the above-mentioned detaching mechanism 33-3 with a particular timing when the four-color-superimposed toner image formed on the intermediate image transfer belt 29 is transferred en bloc therefrom to an image transfer sheet 34, with the application of a predetermined bias voltage to the sheet image transfer bias roller 33-1. Thus, the four-color-superimposed toner image is transferred en bloc to the image transfer sheet 34.

The image transfer sheet 34 to which the four-color-superimposed toner image has been transferred en bloc is then transported by a sheet transporting unit 37 to an image fixing unit (not shown) where the toner image is thermally fixed to the image transfer sheet 34 by an image fixing roller and a pressure application roller (not shown) of which temperature is controlled at a predetermined image fixing temperature, whereby a full-color copy is obtained.

After this second image transfer, the surface of the photoconductor 19 is cleaned with the cleaning unit 20, and uniformly quenched by the quenching lamp 21 for quenching electric charges on the surface of the photoconductor 19. The intermediate image transfer belt 29 is also cleaned with the cleaning unit 32 being brought into pressure contact with the surface of the intermediate image transfer belt 29 by the above-mentioned detaching mechanism with the particular timing after the completion of the image transfer of the final Y toner image to the image transfer sheet 34 from the intermediate image transfer belt 29.

Other features of this invention will become apparent in the course of the following description of exemplary embodiments, which are given for illustration of the invention and are not intended to be limiting thereof.

### Example 1

### Preparation of cyan toner

The following components were mixed to prepare a toner preparation material.

| | Parts by Weight |
|---|---|
| Binder resin: | |
| Epoxy resin | 100.0 |
| (Trademark “R-304”, made by | |
| Mitsui Chemicals, Inc.) | |
| Coloring agent: | |
| Phthalocyanine pigment | 3.7 |
| (Trademark “FG7351”, made by | |
| Toyo Ink Mfg. Co., Ltd.) | |
| Charge control agent: | |
| Zinc salt of salicylic acid | 3.2 |
| (Trademark “Bontron E84”, made by | |
| Orient Chemical Industries, Ltd.) | |

The thus prepared toner preparation material was fused and kneaded in a two-roll mill, and the thus kneaded material was finely pulverized in a jet mill crusher so that the volume mean diameter of the particles might be 12 μm. Then, the obtained particles were subjected to classification and surface treatment using a turbo-mill to which the commercially available pneumatic conveying classifier (Trademark “Dispersion Separator DS-Type”, made by Nippon Pneumatic Mfg. Co., Ltd.) was connected, so that the volume mean diameter of the particles was 11.5 μm.

Further, fine particles were classified, so that there was obtained the classified toner preparation material having a volume mean diameter of 12 μm and comprising finely-divided particles with a particle size of 5 μm or less in an amount of 22% in terms of the percentage of the number of particles contained therein.

To 20 kg of the thus classified toner preparation material, 100 g of a commercially available hydrophobic finely-divided silica particles with an average particle diameter of 0.3 μm (made by Hoechst Japan Looted) and 100 g of a commercially available hydrophobic finely-divided titanium oxide particles with an average particle diameter of 0.3 μm (made by Nippon Aerosil Co., Ltd.) were added, and the resultant mixture was stirred under the following stirring and mixing conditions:

Peripheral speed (V) of agitator blade=20 m/sec

Stirring and mixing time (T)=100 sec

V•T/M=100

Thus, a cyan toner according to the present invention was obtained.

Preparation of intermediate image transfer member

The following components were mixed to prepare a material for an intermediate image transfer member.

Parts by Weight

| | |
|---|---|
| Polyvinylidene fluoride (PVdF) | 100 |
| Carbon black | 10 |

The above obtained mixture was formed into a seamless belt by extrusion, so that an intermediate image transfer belt (A) was obtained. This intermediate image transfer belt (A) and the above prepared cyan toner were set to the commercially available full-color copying machines “PRETER 550” and “PRETER 3000” (Trademark), made by Ricoh Company, Ltd. Then, cyan color toner images were formed and evaluated.

### Example 2

The procedure for preparation of the cyan toner in Example 1 was repeated except that 100 g of the commercially available hydrophobic finely-divided silica particles with an average particle diameter of 0.3 μm (made by Hoechst Japan Limited) was added to 20 kg of the classified toner preparation material.

Thus, a cyan toner according to the present invention was obtained.

Using the same full-color copying machines provided with the same intermediate image transfer belt (A) as employed in Example 1, cyan color toner images were formed and evaluated.

### Example 3

The procedure for preparation of the cyan toner in Example 1 was repeated except that 200 g of the commercially available hydrophobic finely-divided titanium oxide particles with an average particle diameter of 0.3 μm (made by Nippon Aerosil Co., Ltd.) was added to 20 kg of the classified toner preparation material.

Thus, a cyan toner according to the present invention was obtained.

Using the same full-color copying machines provided with the same intermediate image transfer belt (A) as employed in Example 1, cyan color toner images were formed and evaluated.

### Example 4

The procedure for preparation of the cyan toner in Example 1 was repeated except that 100 g of the commercially available hydrophobic finely-divided silica particles with an average particle diameter of 0.01 μm (Trademark “H-2000” made by Hoechst Japan Limited) and 100 g of the commercially available hydrophobic finely-divided titanium oxide particles with an average particle diameter of 0.01 μm (Trademark “T-805” made by Nippon Aerosil Co., Ltd.) were added to 20 kg of the classified toner preparation material.

Thus, a cyan toner according to the present invention was obtained.

Using the same full-color copying machines provided with the same intermediate image transfer belt (A) as employed in Example 1, cyan color toner images were formed and evaluated.

### Example 5

The procedure for preparation of the cyan toner in Example 1 was repeated except that 100 g of the commercially available hydrophobic finely-divided silica particles with an average particle diameter of 0.01 μm (Trademark “H-2000” made by Hoechst Japan Limited) and 60 g of the commercially available hydrophobic finely-divided titanium oxide particles with an average particle diameter of 0.01 μm (Trademark “T-805” made by Nippon Aerosil Co., Ltd.) were added to 20 kg of the classified toner preparation material.

Thus, a cyan toner according to the present invention was obtained.

Using the same full-color copying machines provided with the same intermediate image transfer belt (A) as employed in Example 1, cyan color toner images were formed and evaluated.

### Example 6

The procedure for preparation of the cyan toner in Example 1 was repeated except that 60 g of the commercially available hydrophobic finely-divided silica particles with an average particle diameter of 0.01 μm (Trademark “H-2000” made by Hoechst Japan Limited) and 100 g of the commercially available hydrophobic finely-divided titanium oxide particles with an average particle diameter of 0.01 μm (Trademark “T-805” made by Nippon Aerosil Co., Ltd.) were added to 20 kg of the classified toner preparation material.

Thus, a cyan toner according to the present invention was obtained.

Using the same full-color copying machines provided with the same intermediate image transfer belt (A) as employed in Example 1, cyan color toner images were formed and evaluated.

### Example 7

The same cyan color toner as in Example 1 was prepared.

The procedure for preparation of the intermediate image transfer seamless belt (A) in Example 1 was repeated except that polyvinylidene fluoride was replaced by polycarbonate.

Thus, an intermediate image transfer seamless belt (B) was obtained.

By setting the intermediate image transfer belt (B) and the cyan toner to the same full-color copying machines as employed in Example 1, cyan color toner images were formed and evaluated.

### Example 8

The same cyan toner as in Example 1 was prepared.

The procedure for preparation of the intermediate image transfer seamless belt (A) in Example 1 was repeated except that the amount of carbon black was changed from 10 to 30 parts by weight.

Thus, an intermediate image transfer belt (C) was obtained.

By setting the intermediate image transfer belt (C) and the cyan toner to the same full-color copying machines as employed in Example 1, cyan color toner images were formed and evaluated.

### Example 9

The same cyan toner as in Example 1 was prepared.

The procedure for preparation of the intermediate image transfer seamless belt (A) in Example 1 was repeated except that the amount of carbon black was charred from 10 to one part by weight.

Thus, an intermediate image transfer belt (D) was obtained.

By setting the intermediate image transfer belt (D) and the cyan toner to the same full-color copying machetes as employed in Example 1, cyan color toner images were formed and evaluated.

### Example 10

The toner preparation material composed of the same components as employed in Example 1 was fused and kneaded in a two-roll mill, and the thus kneaded material was finely pulverized in a jet mill crusher so that the volume mean diameter of the particles might be 8 μm.

Then, the obtained particles were subjected to classification and surface treatment using a turbo-mill to which the commercially available pneumatic conveying classifier (Trademark “Dispersion Separator DS-Type”, made by Nippon Pneumatic Mfg. Co., Ltd.) was connected, so that the volume mean diameter of the particles was 7.5 μm.

Further, fine particles were classified, so that there was obtained the classified toner preparation material having a volume mean diameter of 8 μm and comprising finely-divided particles with a particle size of 5 μm or less in an amount of 22% in terms of the percentage of the number of particles contained therein.

To 20 kg of the thus classified toner preparation material, 100 g of the commercially available hydrophobic finely-divided silica particles with an average particle diameter of 0.01 μm (Trademark “H-2000” made by Hoechst Japan Limited) and 60 g of the commercially available hydrophobic finely-divided titanium oxide particles with an average particle diameter of 0.01 μm (Trademark “T-805” made by Nippon Aerosil Co., Ltd.) were added, and the resultant mixture was stirred under the same stirring and mixing conditions as in Example 1.

Thus, a cyan toner according to the present invention was obtained.

Using the same full-color copying machines provided with the same intermediate image transfer belt (A) as employed in Example 1 and the above prepared cyan toner, cyan color toner images were formed and evaluated.

Example 11

The toner preparation material composed of the same components as employed in Example 1 was fused and kneaded in a two-roll mill, and the thus kneaded material was finely pulverized in a jet mill crusher so that the volume mean diameter of the particles might be 8 μm.

Then, the obtained particles were subjected to classification and surface treatment using a turbo-mill to which the commercially available pneumatic conveying classifier (Trademark “Dispersion Separator DS-Type”, made by Nippon Pneumatic Mfg. Co., Ltd.) was connected, so that the volume mean diameter of the particles was 7.5 μm.

Further, fine particles were classified, so that there was obtained the classified toner preparation material having a volume mean diameter of 8 μm and comprising finely-divided particles with a particle size of 5 μm or less in an amount of 16% in terms of the percentage of the number of particles contained therein.

To 20 kg of the thus classified toner preparations material, 100 g of the commercially available hydrophobic finely-divided silica particles with an average particle diameter of 0.01 μm (Trademark “H-2000” made by Roechst Japan Limited) and 60 g of the commercially available hydrophobic finely-divided titanium oxide particles with an average particle diameter of 0.01 μm (Trademark “T-805” made by Nippon Aerosil Co., Ltd.) were added, and the resultant mixture was stirred under the same stirring and mixing conditions as in Example 1.

Thus, a cyan toner according to the present invention was obtained.

Using the same full-color copying machines provided with the same intermediate image transfer belt (A) as employed in Example 1 and the above prepared cyan toner, cyan color toner images were formed and evaluated.

### Example 12

The toner preparation material composed of the same components as employed in Example 1 was fused and kneaded in a two-roll mill, and the thus kneaded material was finely pulverized in a jet mill crusher so that the volume mean diameter of the particles might be 8 μm.

Then, the obtained particles were subjected to classification and surface treatment using a turbo-mill to which the commercially available pneumatic conveying classifier (Trademark “Dispersion Separator DS-Type”, made by Nippon Pneumatic Mfg. Co., Ltd.) was connected, so that the volume mean diameter of the particles was 7.8 μm.

Further, fine particles were classified, so that there was obtained the classified toner preparation material having a volume mean diameter of 8.3 μm and comprising finely-divided particles with a particle size of 5 μm or less in an amount of 16% in terms of the percentage of the number of particles contained therein.

To 20 kg of the thus classified toner preparation material, 100 g of the commercially available hydrophobic finely-divided silica particles with an average particle diameter of 0.01 μm (Trademark “E-2000” made by Hoechst Japan Limited) and 60 g of the commercially available hydrophobic finely-divided titanium oxide particles with an average particle diameter of 0.01 μm (Trademark “T-805” made by Nippon Aerosil Co., Ltd.) were added, and the resultant mixture was stirred under the same stirring and mixing conditions as in Example 1.

Thus, a cyan toner according to the present invention was obtained.

Using the same full-color copying machines provided with the same intermediate image transfer belt (A) as employed in Example 1 and the above prepared cyan toner, cyan color toner images were formed and evaluated.

### Comparative Example 1

The toner preparation material composed of the same components as employed in Example 1 was fused and kneaded in a two-roll mill, and the thus kneaded material was finely pulverized in a jet mill crusher so that the volume mean diameter of the particles might be 12 μm.

Then, the obtained particles were subjected to classification and surface treatment using a turbo-mill to which the commercially available pneumatic conveying classifier (Trademark “Dispersion Separator DS-Type”, made by Nippon Pneumatic Mfg. Co., Ltd.) was connected, so that the volume mean diameter of the particles was 11.5 μm.

Further, fine particles were classified, so that there was obtained the classified toner preparation material having a volume mean diameter of 12 μm and comprising finely-divided particles with a particle size of 5 μm or less in an amount of 22% in terms of the percentage of the number of particles contained therein.

To 20 kg of the thus classified toner preparation material, 100 g of the commercially available hydrophobic finely-divided silica particles with an average particle diameter of 0.3 μm (made by Hoechst Japan Limited) and 100 g of the commercially available hydrophobic finely-divided titanium oxide particles with an average particle diameter of 0.3 μm (made by Nippon Aerosil Co., Ltd.) were added, and the resultant mixture was stirred under the following stirring and mixing conditions:

Peripheral speed (V) of agitator blade30 m/sec

Stirring and mixing time (T)=150 sec

V•T/M=225

Thus, a comparative cyan toner was obtained.

Using the same full-color copying machines provided with the same intermediate image transfer belt (A) as employed in Example 1 and the above prepared comparative cyan toner, cyan color toner images were formed and evaluated.

### Comparative Example 2

The classified toner preparation material composed of the same components as employed in Example 1 was fused and kneaded in a two-roll mill, and the thus kneaded material was finely pulverized in a jet mill crusher so that the volume mean diameter of the particles might be 12 μm.

Then, the obtained particles were subjected to classification and surface treatment using a turbo-mill to which the commercially available pneumatic conveying classifier (Trademark “Dispersion Separator DS-Type”, made by Nippon Pneumatic Mfg. Co., Ltd.) was connected, so that the volume mean diameter of the particles was 11.5 μm.

Further, fine particles were classified, so that there was obtained the classified toner preparation material having a volume mean diameter of 12 μm and comprising finely-divided particles with a particle size of 5 μm or less in an amount of 22% in terms of the percentage of the number of particles contained therein.

To 20 kg of the thus classified toner preparation material, 100 g of the commercially available hydrophobic finely-divided silica particles with an average particle diameter of 0.3 μm (made by Hoechst Japan Limited) and 100 g of the commercially available hydrophobic finely-divided titanium oxide Particles with an average particle diameter of 0.3 μm (made by Nippon Aerosil Co., Ltd.) were added, and the resultant mixture was stirred under the following stirring and mixing conditions:

Peripheral speed (V) of agitator blade=8 m/sec

Stirring and mixing time (T)=100 sec

V•T/M=40

Thus, a comparative cyan toner was obtained.

Using the same full-color copying machines provided with the same intermediate image transfer belt (A) as employed in Example 1 and the above prepared comparative cyan toner, cyan color toner images were formed and evaluated.

### Comparative Example 3

The procedure for preparation of the cyan toner in Example 1 was repeated except that 55 g of the commercially available hydrophobic finely-divided silica particles with an average particle diameter of 0.3 μm (made by Hoechst Japan Limited) and 35 g of the commercially available hydrophobic finely-divided titanium oxide particles with an average particle diameter of 0.3 μm (made by Nippon Aerosil Co., Ltd.) were added to 20 kg of the classified toner preparation material.

Thus, a comparative cyan toner was obtained.

Using the same full-color copying machines provided with the same intermediate image transfer belt (A) as employed in Example 1 and the above prepared comparative cyan toner, cyan color toner images were formed and evaluated.

### Comparative Example 4

The toner preparation material composed of the same components as employed in Example 1 was fused and kneaded in a two-roll mill, and the thus kneaded material was finely pulverized in a jet mill crusher so that the volume mean diameter of the particles might be 11.5 μm.

Further, fine particles were classified, so that there was obtained the classified toner preparation material having a volume mean diameter of 12 μm and comprising finely-divided particles with a particle size of 5 μm or less in an amount of 22% in terms of the percentage of the number of particles contained therein.

To 20 kg of the thus classified toner preparation material, 100 g of the commercially available hydrophobic finely-divided silica particles with an average particle diameter of 0.3 μm (made by Hoechst Japan Limited) and 100 g of the commercially available hydrophobic finely-divided titanium oxide particles with an average particle diameter of 0.3 μm (made by Nippon Aerosil Co., Ltd.) were added, and the, resultant mixture was stirred under the same stirring and mixing conditions as in Example 1.

Thus, a comparative cyan toner was obtained.

Using the same full-color copying machines provided with the same intermediate image transfer belt (A) as employed in Example 1 and the above prepared comparative cyan toner, cyan color toner images were formed and evaluated.

### Comparative Example 5

The toner preparation material composed of the same components as employed in Example 1 was fused and kneaded in a two-roll mill, and the thus kneaded material was finely pulverized in a jet mill crusher so that the volume mean diameter of the particles might be 15 μm.

Then, the obtained particles were subjected to classification and surface treatment using a turbo-mill to which the commercially available pneumatic conveying classifier (Trademark “Dispersion Separator DS-Type”, made by Nippon Pneumatic Mfg. Co., Ltd.) was connected, so that the volume mean diameter of the particles was 11.5 μm .

Further, fine particles were classified, so that there was obtained the classified toner preparation material having a volume mean diameter of 12 μm and comprising finely-divided particles with a particle size of 5 μm or less in an amount of 22% in terms of the percentage of the number of particles contained therein.

To 20 kg of the thus classified toner preparation material, 100 g of the commercially available hydrophobic finely-divided silica particles with an average particle diameter of 0.3 μm (made by Hoechst Japan Limited) and 100 g of the commercially available hydrophobic finely-divided titanium oxide particles with an average particle diameter of 0.3 μm (made by Nippon Aerosil Co., Ltd.) were added, and the resultant mixture was stirred under the same stirring and mixing conditions as in Example 1.

Thus, a comparative cyan toner was obtained.

Using the same full-color copying machines provided with the same intermediate image transfer belt (A) as employed in Example 1 and the above prepared comparative cyan toner, cyan color toner images were formed and evaluated.

### Comparative Example 6

The toner preparation material composed of the same components as employed in Example 1 was fused and kneaded in a two-roll mill, and the thus kneaded material was finely pulverized in a jet mill crusher so that the volume mean diameter of the particles might be 11.5 μm.

Then, the obtained particles were subjected to surface treatment using a turbo-mill, so that the volume mean diameter of the particles was 11.5 μm.

Further, fine particles were classified, so that there was obtained the classified toner preparation material having a volume mean diameter of 12 μm and comprising finely-divided particles with a particle size of 5 μm or less in an amount of 22% in terms of the percentage of the number of particles contained therein.

To 20 kg of the thus classified toner preparation material, 100 g of the commercially available hydrophobic finely-divided silica particles with an average particle diameter of 0.3 μm (made by Hoechst Japan Limited) and 100 g of the commercially available hydrophobic finely-divided titanium oxide particles with an average particle diameter of 0.3 μm (made by Nippon Aerosil Co., Ltd.) were added, and the resultant mixture was stirred under the same stirring and mixing conditions as in Example 1.

Thus, a comparative cyan toner was obtained.

Using the same full-color copying machines provided with the same intermediate image transfer belt (A) as employed in Example 1 and the above prepared comparative cyan toner, cyan color toner images were formed and evaluated.

### Comparative Example 7

The toner preparation material composed of the same components as employed in Example 1 was fused and kneaded in a two-roll mill, and the thus kneaded material was finely pulverized in a jet mill crusher not provided with the pneumatic conveying classifier so that the volume mean diameter of the particles might be 11.5 μm.

Further, fine particles were classified, so that there was obtained the classified toner preparation material having a volume mean diameter of 12 μm and comprising finely-divided particles with a particle size of 5 μm or less in an amount of 22% in terms of the percentage of the number of particles contained therein.

To 20 kg of the thus classified toner preparation material, 100 g of the commercially available hydrophobic finely-divided silica particles with an average particle diameter of 0.3 μm (made by Hoechst Japan Limited) and 100 g of the commercially available hydrophobic finely-divided titanium oxide particles with an average particle diameter of 0.3 μm (made by Nippon Aerosil Co., Ltd.) were added, and the resultant mixture was stirred under the same stirring and mixing conditions as in Example 1.

Thus, a comparative cyan toner was obtained.

Using the same full-color copying machines provided with the same intermediate image transfer belt (A) as employed in Example 1 and the above prepared comparative cyan toner, cyan color toner images were forced and evaluated.

The cyan color toner image was produced using the cyan toner separately prepared in Examples 1 to 12 and Comparative Examples 1 to 7, and evaluated with respect to the following aspects;

(1) The degree of formation of non-image transferred spots in the form of worm-eaten like spots was evaluated on a scale from 1 to 5.

5: No worm-eaten like spots appeared in the transferred toner image.

4: There appeared a few worm-eaten like spots in the transferred toner image, the size of each worm-eaten like spot being to such a degree that it was not easily found with the naked eye. The degree of formation of the worm-eaten like spots was acceptable for practical use.

3: There appeared a lot of worm-eaten like spots in the transferred toner image, the size of each worm-eaten like spot being to such a degree that it was not easily found with the naked eye. The degree of formation of the worm-eaten like spots was not acceptable for practical use.

2: There appeared a few worm-eaten like spots in the transferred toner image, each of the worm-eaten like spots being easily noticeable to the naked eye.

1: There appeared a lot of worm-eaten like spots in the transferred toner image, each of the worm-eaten like spots being easily noticeable to the naked eye.

(2) The degree of scattering of toner particles from development unit was evaluated on a scale from 1 to 4.

4: No toner was scattered from the development unit.

3: Scattering of toner particles from the development unit was slight.

2: Scattering of toner particles from the development unit was noticeable.

1: Scattering of toner particles from the development unit was very noticeable

(3) The degree of toner deposition on the background caused by defective image transfer was evaluated on a scale from 1 to 5.

5: No toner deposition on the background occurred.

4: Toner deposition on the background was not confirmed by visual observation, but slightly confirmed with a magnifier. The degree of toner deposition on the background was acceptable for practical use.

3: Toner deposition on the background was scarcely confirmed by visual observation, but confirmed at several positions with a magnifier. The degree of toner deposition on the background was not acceptable for practical use.

2: Toner deposition on the background was confirmed by visual observation.

1: It was confirmed by visual observation that a character image became blurred because of toner deposition on the background.

(4) The degree of formation of non-image transferred spots in a solid image, like the glow of fireflies in the dark, was evaluated on a scale from 1 to 3.

An entire solid image was produced on 10 sheets of A3 size. The number of non-image transferred spots in the form of the glow of fireflies in the dark was counted throughout the ten sheets. The fewer, the better the image quality.

3: The number of non-image transferred spots was less than 3.

2: The number of non-image transferred spots was in the range of 3 to 15.

1: The number of non-image transferred spots was 16 or more.

(5) Resolution was evaluated on a scale from 1 to 4.

The resolution of a toner image was evaluated by the reproducibilities of line images, using a chart composed of line images, each having a plurality of vertical lines or horizontal lines. More specifically, each line image had 2.0, 2.2, 2.5, 2.8, 3.2, 3.6, 4.0, 4.5, 5.0, 5.6, 6.3, or 7.1 lines, with these lines being arranged in parallel at regular intervals within a space of 1 mm. The number of lines within a space of 1 mm that was faithfully reproduced was regarded as the resolution.

4: It was possible to faithfully reproduce a line image with 5.0 lines or more.

3: It was possible to faithfully reproduce a line image with 4.5 lines or less.

2: It was possible to faithfully reproduce a line image with 3.6 lines or less.

1: A line image with 3.2 lines was not faithfully reproduced.

(6) Image transfer performance was evaluated on a scale from 1 to 4.

The image transfer performance was evaluated in terms of the maximum printable number of copy papers.

In this case, making of copies was continued using a chart of A4 size including an image portion at an area ratio of 6% until 100 g of a color toner was completely consumed. The more the printable number of copy papers, the better the image transfer performance. The smaller the amount of residual toner on the photoconductor drum after the completion of image transfer step, the better the image transfer performance.

4: The maximum printable number of copy papers was 3,500 or more.

3: The maximum printable number of copy papers was 3,000 or more and less than 3,500.

2: The maximum printable number of copy papers was 2,500 or more and less than 3,000.

1: The maximum printable number of copy papers was less than 2,500.

The results of the above-mentioned evaluations are shown in TABLE 1.

TABLE I

| | Intermediate Image | | Toner | | | Evaluations after Image Formation | | | | | | | | | | | |
|---|---|---|---|---|---|---|---|---|---|---|---|---|---|---|---|---|---|
| | Transfer Member | | | Amount of | | Non-image | | | | | | | | | | | |
| | Coeffi- | | | residual | | trans- | | | | | | Non-image | | | | | |
| | cient | | | toner | Charge | ferred | | | | | | trans- | | | | Image | |
| | of | Volume | Aver- | after | rise- | worm-eaten | | Scatter- | | Toner | | ferred spots | | | | transfer | |
| | surface | resisti- | age | 500-mesh | up | like spots | | ing of | | deposi- | | in solid | | Resolu- | | perform- | |
| | fric- | vity | circu- | sieve | ratio | * | | toner | | tion | | image | | tion | | ance | |
| | tion | (Ω · cm) | larity | (mg/100 g) | (%) | \mathring{1} | \mathring{2} | \mathring{1} | \mathring{2} | \mathring{1} | \mathring{2} | \mathring{1} | \mathring{2} | \mathring{1} | \mathring{2} | \mathring{1} | \mathring{2} |
| Ex. 1 | 0.23 | 5.00 × 10¹⁰ | 0.96 | 9 | 73 | 4 | 4 | 4 | 3 | 4 | 4 | 3 | 3 | 3 | 3 | 4 | 4 |
| Ex. 2 | 0.23 | 5.00 × 10¹⁰ | 0.96 | 9 | 77 | 4 | 4 | 4 | 4 | 4 | 4 | 3 | 3 | 3 | 3 | 4 | 4 |
| Ex. 3 | 0.23 | 5.00 × 10¹⁰ | 0.96 | 6 | 65 | 4 | 4 | 3 | 3 | 4 | 4 | 3 | 3 | 3 | 3 | 3 | 3 |
| Ex. 4 | 0.23 | 5.00 × 10¹⁰ | 0.96 | 1 | 73 | 4 | 4 | 4 | 3 | 4 | 4 | 3 | 3 | 3 | 3 | 4 | 4 |
| Ex. 5 | 0.23 | 5.00 × 10¹⁰ | 0.96 | 3 | 85 | 4 | 4 | 4 | 4 | 4 | 4 | 3 | 3 | 3 | 3 | 4 | 4 |
| Ex. 6 | 0.23 | 5.00 × 10¹⁰ | 0.96 | 6 | 71 | 4 | 4 | 4 | 4 | 4 | 4 | 3 | 3 | 3 | 3 | 4 | 4 |
| Ex. 7 | 0.45 | 5.00 × 10¹⁰ | 0.96 | 9 | 73 | 3 | 3 | 4 | 4 | 4 | 4 | 3 | 3 | 3 | 3 | 3 | 3 |
| Ex. 8 | 0.25 | 3.50 × 10⁷ | 0.96 | 9 | 73 | 4 | 4 | 4 | 4 | 3 | 3 | 3 | 3 | 3 | 3 | 3 | 3 |
| Ex. 9 | 0.27 | 7.40 × 10¹⁴ | 0.96 | 9 | 73 | 3 | 3 | 4 | 4 | 4 | 4 | 3 | 3 | 3 | 3 | 3 | 3 |
| Ex. 10 | 0.23 | 5.00 × 10¹⁰ | 0.96 | 6 | 98 | 4 | 4 | 4 | 4 | 4 | 4 | 3 | 3 | 4 | 4 | 4 | 4 |
| Ex. 11 | 0.23 | 5.00 × 10¹⁰ | 0.96 | 1 | 97 | 5 | 5 | 4 | 4 | 5 | 5 | 3 | 3 | 4 | 4 | 4 | 4 |
| Ex. 12 | 0.23 | 5.00 × 10¹⁰ | 0.94 | 3 | 94 | 5 | 5 | 4 | 4 | 5 | 5 | 3 | 3 | 4 | 4 | 4 | 4 |
| Comp. | 0.23 | 5.00 × 10¹⁰ | 0.98 | 15 | 73 | 2 | 2 | 3 | 3 | 2 | 2 | 1 | 1 | 2 | 2 | 3 | 2 |
| Ex. 1 | | | | | | | | | | | | | | | | | |
| Comp. | 0.23 | 5.00 × 10¹⁰ | 0.96 | 33 | 43 | 1 | 1 | 1 | 1 | 2 | 2 | 1 | 1 | 1 | 1 | 1 | 1 |
| Ex. 2 | | | | | | | | | | | | | | | | | |
| Comp. | 0.23 | 5.00 × 10¹⁰ | 0.96 | 20 | 40 | 2 | 2 | 1 | 1 | 2 | 2 | 1 | 1 | 1 | 1 | 1 | 1 |
| Ex. 3 | | | | | | | | | | | | | | | | | |
| Comp. | 0.23 | 5.00 × 10¹⁰ | 0.92 | 14 | 55 | 2 | 2 | 2 | 2 | 2 | 2 | 1 | 1 | 2 | 2 | 1 | 1 |
| Ex. 4 | | | | | | | | | | | | | | | | | |
| Comp. | 0.23 | 5.00 × 10¹⁰ | 0.98 | 18 | 78 | 2 | 2 | 3 | 3 | 2 | 2 | 1 | 1 | 2 | 2 | 3 | 2 |
| Ex. 5 | | | | | | | | | | | | | | | | | |
| Comp. | 0.23 | 5.00 × 10¹⁰ | 0.92 | 12 | 58 | 3 | 3 | 2 | 2 | 3 | 3 | 2 | 2 | 2 | 2 | 1 | 1 |
| Ex. 6 | | | | | | | | | | | | | | | | | |
| Comp. | 0.23 | 5.00 × 10¹⁰ | 0.90 | 38 | 36 | 1 | 1 | 1 | 1 | 1 | 1 | 1 | 1 | 1 | 1 | 1 | 1 |
| Ex. 7 | | | | | | | | | | | | | | | | | |

(*)\mathring{1}The copying machine “PRETER 550” (Trademark) was employed.
\mathring{2}The copying machine “PRETER 300” (Trademark) was employed.

As previously explained, a kneaded toner preparation material comprising a binder resin, a coloring agent and a charge control agent is roughly ground, and thereafter subjected to pulverizing using, for example, a jet crusher, and then classifying and sphericity adjustment treatment using a pneumatic conveying classifier which is connected to the rotor type crusher. Then, a fluidity-imparting agent is mixed with the classified toner preparation material under the conditions which satisfy a formula 50≦(V•T)/M≦200, in which V is a peripheral speed of the rotary agitator blade, T is a stirring and mixing time (sec), and M is a weight (kg) of the toner to be stirred and mixed.

According to the above-mentioned preparation method, a toner for use in electrophotography can be efficiently obtained with no difficulty.

The toner particles for use in the toner of the present invention have an average circularity of 0.93 to 0.97, with a residue of the toner being in an amount of 10 mg or less when 100 g of the toner is sieved with a 500-mesh sieve. By use of such a toner, high quality toner images can be obtained free of non-image transferred spots in the form of the glow of fireflies in the dark.

When the toner of the present invention is used as one toner in a set of toners for use in a full-color electrophotography, the effect of improving the image quality is remarkable. To be more specific, when the tone is used in a full-color copying machine provided with an intermediate image transfer member having a volume resistivity of 10⁹ to 10³³ ω•cm and a coefficient of surface friction of 0.4 or less, the obtained color images are free from non-image transferred spots in the form of worm-eaten like spots or non-transferred spots in a solid image just like the glow of fire flies in the dark.

Further, when the charge rise-up ratio of the toner is 70% or more, the image transfer performance becomes excellent, and the image density can be stabilized. At the same time, the scattering of toner particles from the development unit can be prevented.

Furthermore, when the fluidity-imparting agent comprises both hydrophobic silica particles and hydrophobic titanium oxide particles, the fluidity and the preservation stability of toner can be improved, and the environmental stability of toner can be ensured.

In addition, when the toner has a volume mean diameter of 9 μm or less, and comprises finely-divided particles with a particle size of 5 μm or less in an amount of 20% in terms of the percentage of the number of particles contained therein, the obtained toner image becomes clearer because of tee increase in resolution.

When the toner of the present invention is used in a full-color electrophotographic apparatus for forming a full-color toner image by developing a latent electrostatic image formed on the photoconductor drum, using a reversal development method, in which there is rotated a development unit comprising a plurality of development devices and magnetic brushes therefor, the effect of improving the image quality is striking.

Japanese Patent Application No. 10-256090 filed Aug. 27, 1998 is hereby incorporated by reference.

What is claimed is:

1. A toner comprising toner particles and a fluidity-imparting agent, said toner particles having an average circularity of 0.93 to 0.97, with a residue of said toner being in an amount of 10 mg or less when 100 g of said toner is sieved with a 500-mesh sieve, said toner being for use in an electrophotographic image formation method using an intermediate image transfer method which comprises (1) a first image transfer step of transferring a toner image formed on a toner image bearing member from said toner image bearing member to an endless-shaped intermediate image transfer member so as to form a toner image thereon, and (2) a second image transfer step of transferring said toner image from said intermediate image transfer member to an image transfer material.

2. The toner as claimed in claim 1, wherein said toner is one toner in a set of toners for use in a full-color electrophotography, which comprises at least a yellow toner, a magenta toner, and a cyan toner.

3. The toner as claimed in claim 1, wherein said toner exhibits a charge rise-up ratio Z of 70% or more, which is calculated from formula (1):
Z(%)=(Q20/Q600)×100 (1)
wherein Q600 is a quantity of charge of said toner when said toner and a carrier are mixed and stirred for 10 minutes, with a concentration ratio of said toner in the mixture of said toner and said carrier being set at 5 wt. % or less at normal temperature and normal humidity, and Q20 is a quantity of charge of said toner when said toner is mixed with said carrier for 20 seconds under the same conditions as for said Q600.

4. The toner as claimed in claim 1, wherein said fluidity-imparting agent comprises hydrophobic silica particles and hydrophobic titanium oxide particles.

5. The toner as claimed in claim 1, wherein said fluidity-imparting agent has an average particle diameter of 0.05 μm or less.

6. The toner as claimed in claim 1, wherein said fluidity-imparting agent comprises hydrophobic silica particles with an average particle diameter of 0.05 μm or less in an amount of 0.3 to 1.5 wt. %, and hydrophobic titanium oxide particles with an average particle diameter of 0.05 μm or less in an amount of 0.3 to 1.5 wt. %.

7. The toner as claimed in claim 1, wherein said toner has a volume mean diameter of 9 μm or less.

8. The toner as claimed in claim 7, wherein said toner comprises toner particles with a particle size of 5 μm or less in an amount of 20% or less in terms of the percentage of the number of said toner particles contained therein.

9. A full-color image formation method for forming full-color images, using a toner comprising toner particles and a fluidity-imparting agent, said toner particles having an average circularity of 0.93 to 0.97, with a residue of said toner being in an amount of 10 mg or less when 100 g of said toner is sieved with a 500-mesh sieve, said full-color electrophotographic image formation method using an intermediate image transfer method comprising (1) a first image transfer step of repeating a plurality of times the transfer of a toner image formed on a toner image bearing member successively from said toner image bearing member to an endless-shaped intermediate image transfer member so as to form a superimposed toner image, and (2) a second image transfer step of transferring said superimposed toner image en bloc from said intermediate image transfer member to an image transfer material.

10. The full-color image formation method as claimed in claim 9, wherein said toner is one toner in a set of toners comprising at least a yellow toner, a magenta toner, and a cyan toner.

11. The full-color image formation method as claimed in claim 9, wherein said toner exhibits a charge rise-up ratio Z of 70% or more, which is calculated from formula (1):
Z(%)=(Q20/Q600)×100 (1)
wherein Q600 is a quantity of charge of said toner when said toner and a carrier are mixed and stirred for 10 minutes, with a concentration ratio of said toner in the mixture of said toner and said carrier being set at 5 wt. % or less at normal temperature and normal humidity, and Q20 is a quantity of charge of said toner when said toner is mixed with said carrier for 20 seconds under the same conditions as for said Q600.

12. The full-color image formation method as claimed in claim 9, wherein said fluidity-imparting agent comprises hydrophobic silica particles and hydrophobic titanium oxide particles.

13. The full-color image formation method as claimed in claim 9, wherein said fluidity-imparting agent has an average particle diameter of 0.05 μm or less.

14. The full-color image formation method as claimed in claim 9, wherein said fluidity-imparting agent comprises hydrophobic silica particles with an average particle diameter of 0.05 μm or less in an amount of 0.3 to 1.5 wt. %, and hydrophobic titanium oxide particles with an average particle diameter of 0.05 μm or less in an amount of 0.3 to 1.5 wt. %.

15. The full-color image formation method as claimed in claim 9, wherein said toner has a volume mean diameter of 9 μm or less.

16. The full-color image formation method as claimed in claim 15, wherein said toner comprises toner particles with a particle size of 5 μm or less in an amount of 20% or less in terms of the percentage of the number of said toner particles contained therein.

17. The full-color image formation method as claimed in claim 9, wherein said intermediate image transfer member has a volume resistivity of 10⁹ to 10³³ •ωcm and a coefficient of surface friction of 0.4 or less.

18. The full-color image formation method as claimed in claim 9, wherein said toner image formed on said toner image bearing member is such a toner image that is formed by developing a latent electrostatic image formed on a photoconductor drum, using a reversal development method in which there is rotated a development unit comprising a plurality of development devices and magnetic brushes therefor.

19. The full-color image formation method as claimed in claim 17, wherein said toner image formed on said toner image bearing member is such a toner image that is formed by developing a latent electrostatic image formed on a photoconductor drum, using a reversal development method in which there is rotated a development unit comprising a plurality of development devices and magnetic brushes therefore.

20. The full-color image formation method as claimed in claim 18, wherein said toner is held in a rotary toner supply container free of any rotary agitator blade, and said rotary toner supply container is disposed in each of said development devices.

21. The full-color image formation method as claimed in claim 19, wherein said toner is held in a rotary toner supply container free of any rotary agitator blade, and said rotary toner supply container is disposed in each of said development devices.

22. A method of producing a toner for use in electrophotography, comprising the step of mixing a fluidity-imparting agent with a classified toner preparation material, using a rotary agitator blade mixer equipped with a rotary agitator blade, under the conditions which satisfy a formula:
50≦(V•T)/M≦200
wherein V is a peripheral speed (msec) of said rotary agitator blade of said rotary agitator blade mixer, T is a stirring and mixing time (sec) , and M is a weight (kg) of said toner to be stirred and mixed.

23. The method of producing the toner for use in electrophotography as claimed in claim 22, wherein (1) said classified toner preparation material is obtained by subjecting a toner preparation material to secondary pulverizing, using a rotor type crusher comprising a fixed container serving as an external wall and a rotor having the same rotary shaft as that for said fixed container, (2) said toner preparation material subjected to said secondary pulverizing is classified, using a pneumatic conveying classifier which is connected to said rotor type crusher, and (3) said pulverized and classified toner preparation material is circulated through said rotor type crusher and said pneumatic conveying classifier.

24. The method of producing the toner for use in electrophotography as claimed in claim 23, wherein said toner preparation material is subjected to primary pulverizing, using a jet crusher comprising a detector, and compressed air, prior to said secondary pulverizing.

25. An apparatus for producing a toner for use in electrophotography comprising:
a rotor type crusher comprising a fixed container serving as an external wall and a rotor having the same rotary shaft as that for said fixed container, and
a pneumatic conveying classifier which is connected to said rotor type crusher, through said rotor type crusher and said pneumatic conveying classifier, a classified toner preparation material being circulated.

26. A rotary toner supply container free of any rotary agitator blade, in which there is held a toner which comprises toner particles and a fluidity-imparting agent, said toner particles having an average circularity of 0.93 to 0.97, with a residue of said toner being in an amount of 10 mg or less when 100 g or said toner is sieved with a 500-mesh sieve, said toner being for use in an electrophotographic image formation method using an intermediate image transfer method which comprises (1) a first image transfer step of transferring a toner image formed on a toner image bearing member from said toner image bearing member to an endless-shaped intermediate image transfer member so as to form a toner image thereon, and (2) a second image transfer step of transferring said toner image from said intermediate image transfer member to an image transfer material.

27. The rotary toner supply container as claimed in claim 26, wherein said toner is one toner in a set of toners for use in a full-color electrophotography, which comprises at least a yellow toner, a magenta toner, and a cyan toner.

28. The rotary toner supply container as claimed in claim 26, wherein said toner exhibits a charge rise-up ratio Z of 70% or more, which is calculated from formula (1):
Z(%)=(Q20/Q600)×100 (1)
wherein Q600 is a quantity of charge of said toner when said toner and a carrier are mixed and stirred for 10 minutes, with a concentration ratio of said toner in the mixture of said toner and said carrier being set at 5 wt. % or less at normal temperature and normal humidity, and Q20 is a quantity of charge of said toner when said toner is mixed with said carrier for 20 seconds under the same conditions as for said Q600.

29. The rotary toner supply container as claimed in claim 26, wherein said fluidity-imparting agent comprises hydrophobic silica particles and hydrophobic titanium oxide particles.

30. The rotary toner supply container as claimed in claim 26, wherein said fluidity-imparting agent has an average particle diameter of 0.05 μm or less.

31. The rotary toner supply container as claimed in claim 26, wherein said fluidity-imparting agent comprises hydrophobic silica particles with an average particle diameter of 0.05 μm or less in an amount of 0.3 to 1.5 wt. %, and hydrophobic titanium oxide particles with an average particle diameter of 0.05 μm or less in an amount of 0.3 to 1.5 wt. %.

32. The rotary toner supply container as claimed in claim 26, wherein said toner has a volume mean diameter of 9 μm or less.

33. The rotary toner supply container as claimed in claim 32, wherein said toner comprises toner particles with a particle size of 5 μm or less in an amount of 20% or less in terms of the percentage of the number of said toner particles contained therein.
